(19) United States
(12) Patent Application Publication
(10) Pub. No.: US 2003/0093798 A1
(43) Pub. Date: May 15, 2003

(54) Modular entertainment system configured for multiple broadband content delivery incorporating a distributed server

(76) Inventor: Michael Rogerson, Irvine, CA (US)

Correspondence Address: STRADLING YOCCA CARLSON & RAUTH, IP Department, 660 Newport Center Drive, Suite 1600, P.O. Box 7680, Newport Beach, CA, 92660-6441, US

(21) Appl. No.: 10/194,429

(22) Filed: Jul. 11, 2002

Related U.S. Application Data
(63) Continuation-in-part of application No. 09/613,340, filed on Jul. 10, 2000.
(60) Provisional application No. 60/304,884, filed on Jul. 11, 2001.

(51) Int. Cl. H04N 7/18

(52) U.S. Cl. 725/75; 725/74

(57) ABSTRACT

In-flight passenger entertainment system for an aircraft or other vehicle, utilizes a distributed network server architecture to host and support a variety of audio/visual content providing applications. A communications management unit provides connectivity between the distributed network architecture and various satellite, wireless, or ground broadband signal sources. A distributed server architecture implemented in a wireless LAN configuration, allows passengers to access World Wide Web functionality, e-mail functionality as well as multimedia content, broadcast television, cellular telephone communication, and the like. Individual nodes of the distributed network architecture host individual ones of the various communication applications such that a central server and centralized distribution network is no longer necessary.

### CROSS REFERENCE TO RELATED APPLICATIONS

The present application is a continuation-in-part of co-pending U.S. patent application Ser. No. 09/613,340, filed Jul. 10, 2000, and is related to and additionally takes priority from U.S. Provisional Patent Application Serial No. 60/304,884d Jul. 11, 2001, both commonly owned by the assignee of the present invention, the entire contents of which are expressly incorporated herein by reference.

### FIELD OF THE INVENTION

The present invention is directed to an entertainment and content delivery network and, more particularly, is directed to a modular entertainment network system for use in aircraft and other passenger vehicles.

### BACKGROUND OF THE INVENTION

During the past several years, commercial air travel has grown increasingly in importance, with more and more passengers availing themselves of commercial air routes. As more people travel in an limited number of carrier vehicles, airlines have taken to offering in-flight entertainment and communication services to such passengers in an effort to create an environment to the necessary confinement attendant upon air travel. In order to improve passenger comfort, in-flight entertainment and communication systems typically offer various forms of in-flight video, such as movies, infomercials and the like and might also include a variety of other services such as music, games, and on-board telephony for the business traveler.

In recent years, certain commercial airline systems manufacturers have been developing more advanced in-flight entertainment systems which offer a greater variety of in-flight entertainment such as pay-per-view movies, hotel reservations services, localized catalog shopping services, and the like.

However, prior art-type in-flight entertainment systems, including the more advanced systems under development, suffer from severe architectural deficiencies in their current implementation and further are not configured to mirror the ground communication environment which is familiar to most passengers. In terms of architectural deficiencies, many conventional systems distribute multimedia information (audio and video) over analog signal lines. This requires that such systems include modulation and demodulation devices at both the head end and at a downstream receiver. Provision of such additional devices in order to effect communication between a signal source and a video display, for example, add significantly to the component count within an aircraft fuselage as well as adding a weight and power consumption penalty to existing equipment. Further, most conventional systems are configured with a number of satellite displays, all controlled and sourced by a centrally disposed multimedia server which actually runs the multiplicity of applications available to a passenger.

Since different passengers are able to invoke different applications, and view different content on a local display, all of the different content must be provided simultaneously on a network signal bus by the single server system. It is easy to understand the bandwidth constraints that this necessarily imposes on a network signal bus.

Certain modifications have been made to existing system to partially overcome the problem of bandwidth constraint. One such modification involves locating a set of cluster computers as various positions throughout an aircraft cabin. Each cluster computer provides the control functionality and content provision features for a given cluster of seats, so as to minimize the bandwidth demands on any one centralized server.

Although effective in some degree, this particular system must nevertheless pay a substantial weight, power consumption and component count penalty over existing in-flight entertainment systems. Further, each cluster is wired in a star configuration, requiring that each seat display be individually facilitated with a wiring harness specific to the system architecture. In addition to further adding weight, adding an additional wiring harness to an aircraft system would result in an increased maintenance schedule as well as increased maintenance costs.

All of the prior art-type architectures are predicated upon content being provided by a centrally located “bank” of content sources. Content is typically stored in large arrays of mass storage media which might have some provision for random access in order to accommodate video-on-demand or audio-on-demand functionality. Very few of these prior art-type systems are capable of accessing the world outside the aircraft cabin in order to acquire additional content items or to inform, modify or update their stored content. Some recent systems have proposed receiving a specific form of content from a specific satellite constellation, provided particularly for such purpose. Although this is a step in the right direction, the type of content is substantially limited and the system is itself architected as a stand-alone distribution source that relies solely and specifically on that satellite constellation for off-board content provision.

Even given their architectural deficiencies, modern in-flight entertainment systems are particularly disadvantageous when it is understood that the type and form of content they provide does not mirror the experience a passenger receives when they interface with a ground-based communication environment. Specifically, although a ground-based environment also is able to deliver audio and video content on demand, it is also able to connect a user to the World Wide Web from which an almost infinite amount of content can be extracted. Connection to the World Wide Web also allows a user to facilitate various business arrangements by communicating with potential vendors, customers, and the like through web-based applications.

A commercial traveler, no less than one who is office bound, often wishes to access web-based information, make web-based purchases or communicate with the rest of the world via e-mail.

This is a particular content source which has not heretofore been addressed by any in-flight entertainment systems and which would certainly offer richer and more varied content than is currently practicable.

What is therefore needed is an in-flight entertainment system that incorporates existing audio and video on demand functionality, but also includes the ability to deliver content from applications that mirror the World Wide Web. Web access can be used to provide in-flight books, music, video, and the like as well as some of the more commercial aspects of the web, such as on-line purchasing and/or information exchange. Passengers are thus able to operate in an environment much like their own ground-based environment and are able to communicate and interact with their applications in a familiar manner.

Pertinent to this functionality, the system should be able to access a number of off-board signal sources, without requiring a stand-alone system for each communication media. For example, the system should be able to effect communication between a number of satellite constellations, as well as over broadband radio and/or wireless communication media. All of these various signal sources should be able to be utilized in order to extract content therefrom, with the content being provided to a simple network architecture such that it can be locally stored and made available to passengers in an effective manner. The network itself should be implemented such that it does not require a large, central server system as an engine. Rather, the network should be transparent to the other on-board aircraft systems and should be implemented with a minimum component count and a consequent minimum of power supply draw. Such an in-flight entertainment system would be lighter, easier to maintain and easier to reconfigure than existing systems.

### BRIEF SUMMARY OF THE INVENTION

The present invention relates generally to systems for distributing mixed media content to passengers in a private or commercial vehicle, such as an aircraft, bus or train. The system generally includes a plurality of display devices, with each device including an electronics package comprising at least a control processor, a local memory storage area and a graphical display. The display devices are interconnected by a local area network signal bus so as to define a local area network. Each of the display devices is configured to function as a network server, as well as a client device, such that the plurality of display devices cooperate over the local area network signal bus to define a distributed server local area network architecture.

In a particular aspect of the invention, each of the plurality of display devices defines a network node of the distributed server local area network architecture. A number of content providing application software routines are distributed across the plurality of devices, such that the particular ones of the application software routines are stored on corresponding particular ones of the plurality of network nodes. Each network node thus hosts only a specific sub-set of the content providing applications.

In a further aspect of the invention, the plurality of content providing application software routines allow the various network nodes to function as individual application servers within the network. One network node functions as an e-mail server, a second network node functions as a web server, or alternatively supports a portion of the web server functionality. An additional network node functions as an electronic book server, while a further network node functions as a server for audio or video-on-demand.

In an additional aspect of the invention, a communication management unit is coupled to the network signal bus and is further coupled to multiple bi-directional interface devices, each communication interface device affecting real-time communication with a different one of a multiplicity of substantially incompatible off-board signal sources. Incompatible signal sources include a first satellite constellation, capable of providing a first type of content, such as broadcast television programming. A second satellite constellation provides a second type of content, such as a cellular telephony communication medium. A further incompatible signal source includes a broadband bi-directional VHF communication medium.

Content provided by the substantially incompatible signal sources, through the communication management unit, is directed to particular ones of the plurality of display devices, depending upon whether a passenger using that device wishes to access that form or type of content. Content delivery is made to each display device, with the display device functioning as a client device, from the corresponding hosting server device on the network. Thus, each display device functions as both a content delivery server and as a content receiving client in a manner transparent to a user or passenger.

### BRIEF DESCRIPTION OF THE DRAWINGS

These and other features, aspects and advantages of the invention will be more fully understood when considered in connection with the following description, appended claims and accompanying drawings, wherein:

FIG. 1 is a simplified, semi-schematic block diagram of the components of a modular entertainment system in accordance with practice of the present invention;

FIG. 2 is a simplified, semi-schematic block diagram of the connectivity configuration of a modular entertainment system according to the invention;

FIG. 3 is a simplified semi-schematic block diagram of an electronic switch and communication management unit suitable for incorporation into the modular entertainment system of the present invention;

FIG. 4 is a simplified, semi-schematic block diagram of a non-blocking electronic switch suitable for use in connection with the communication management unit of FIG. 3;

FIG. 5 is a simplified, semi-schematic block diagram of the component parts of a communication management unit such as depicted in the embodiment of FIG. 3;

FIG. 5A is a simplified semi-schematic block diagram of an additional embodiment of a communication management unit suitable for incorporation into the modular entertainment system of the present invention;

FIG. 5B is a simplified, semi-schematic block diagram of the routing functionality of the communication management unit of FIG. 5A;

FIG. 6 is a simplified, semi-schematic block diagram of the component parts of a network node of the modular entertainment system in accordance with the present invention;

FIG. 6A is a simplified, semi-schematic block diagram of the component parts of an additional embodiment of a network node unit;

FIG. 6B is a simplified, semi-schematic block diagram of the functional logical blocks of one embodiment of an I/O circuit suitable for implementation in the network node of FIG. 6A;

FIG. 6C is a simplified, semi-schematic block diagram of the functional logical blocks of a second embodiment of an I/O circuit suitable for implementation in the network node of FIG. 6A;

FIG. 6D is a simplified, semi-schematic block diagram of the functional logical blocks of a common processor implementation suitable for implementation in the network node of FIG. 6A;

FIG. 7 is an illustration of the frequency bands available for unlicensed wireless communication applications in the high MHz and low GHz spectral regions;

FIG. 8 is a simplified representation of an ad-hoc wireless network configuration;

FIG. 9 is a simplified representation of a wireless network configured as an infrastructure network;

FIG. 10 is a simplified, semi-schematic illustration of a MAC and PHY architecture suitable for use in connection with the invention;

FIG. 11 is a data rate and modulation table for an ODFM transmission methodology illustrating the change in modulation constellation definition with desired data rate;

FIG. 12 is a simplified, semi-schematic illustration of an OFDM transmitter architecture suitable for practice of the invention;

FIG. 13 is a simplified, semi-schematic illustration of an OFDM receiver architecture suitable for practice of the invention;

FIG. 14 is a graphical illustration of BPSK, QPSK, 16 QAM and 64 QAM constellations.

### DETAILED DESCRIPTION OF THE INVENTION

Initially, the present invention will be described in connection with an in-flight entertainment system (IES) of the type commonly provided in passenger aircraft for the comfort and amusement of passengers. While the invention is described in terms of its use in connection with passenger aircraft, it should be understood that the term passenger aircraft is intended to include, not only large commercial passenger jets, but also business and corporate aircraft, as well as single and twin engine multi-seat aircraft capable of carrying anywhere from two to six or eight passengers in addition to the pilot.

Pertinent to this description is the recognition that aircraft are not the only vehicles configured to and capable of carrying multiple passenger. Indeed, similar such vehicles might include multiple passenger carrying buses, trains, and even van or wagon configured automobiles, where the passengers typically occupy seating arrangements which are separate from the driver or operator of the vehicle.

Thus, even though described in the context of an aircraft system, it will be understood that the modular entertainment system according to the invention, is admirably suited for incorporation into any vehicle in which passengers might need to be either amused, entertained, or might need to communicate with the outside world, during relatively long travel periods. Any of the vehicles described above, and other vehicles that might come into the contemplation of one having skill in this particular art, can be immediately recognized as having severe constraints on their ability to provide operational power to an entertainment or communication system, by virtue of their being necessarily detached from the universal power grid. All of the power in these vehicles is self-contained or self-generated and is necessarily limited. Accordingly, the nature of the entertainment and communication system of the present invention, as well as its low power draw is particularly advantageous for use in such vehicles.

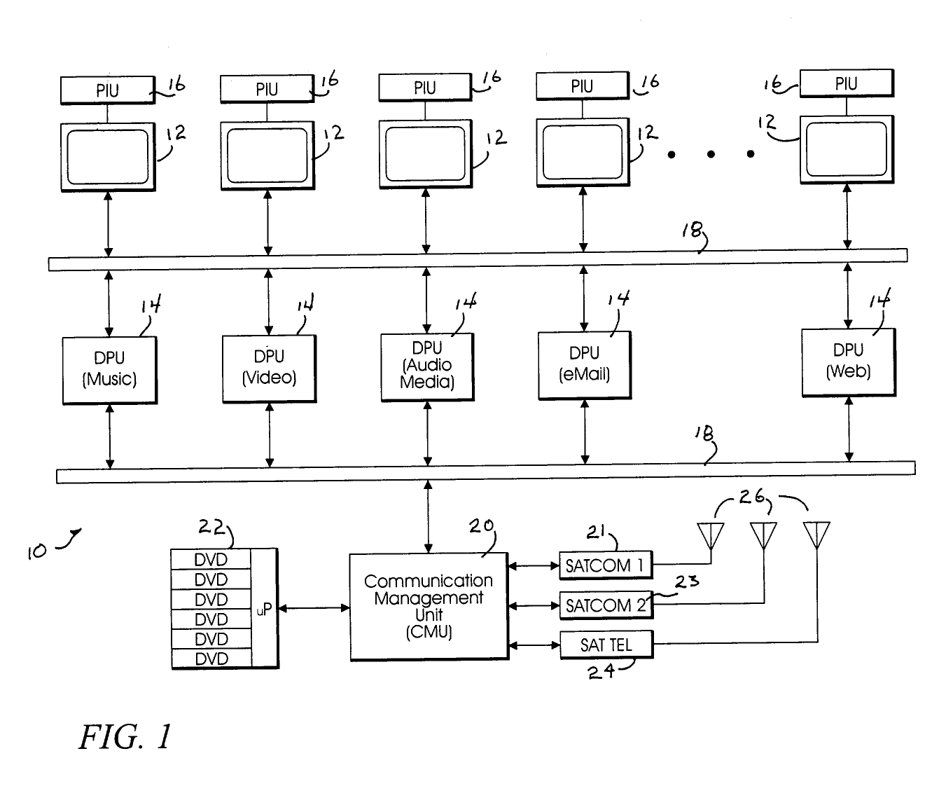

Turning now to FIG. 1, a particular exemplary embodiment of a modular entertainment and communications system, in accordance with the invention, is shown in simplified, semi-schematic block diagram form, and generally indicated at 10. The modular entertainment and communication system 10 is configured as an in-flight entertainment system, the components of which are distributed about the fuselage of an aircraft in such a manner as to be relatively unobtrusive and consume a minimal amount of power. Typically, an aircraft, such as a commercial airliner or business aircraft, will include a number of passenger seats disposed in a variety of configurations. In a typical aircraft, the back portion of each seat is configured to contain an electronics package whose footprint is defined by a graphics display screen 12 which is mounted on the back of each passenger seat in a position so as to be easily viewable and accessible by a passenger seated immediately behind that seat. Alternatively, it should be noted that in aircraft having other types of seat configurations, such as corporate or business aircraft, where seats are not typically disposed one behind the other, the electronics package, including the graphics display unit 12 might be mounted on the armrest of the seat or on an articulated arm structure by means of which the electronics package can be maneuvered into a readily accessible and viewable position by a passenger. In other words, the actual mounting position of the electronics package, including the graphics display unit 12 is not particularly relevant to the present invention. All that is required is that the electronics package be mounted in a manner suitable for easy access and viewing.

The graphics display screen 12 itself is contemplated as being implemented as a flat panel display, such as a liquid crystal display (LCD), or some other suitable flat panel-type display device capable of operating at resolutions at least in the range of 480×640 pixels, although, as will be described in greater detail below, higher resolutions would be preferable in certain circumstances in which very fine detail would contribute positively to the viewing experience. In this regard, it should be noted that such graphical display screens are commonly implemented in laptop-type computers and such high resolution, color capable LCD displays are certainly capable of providing the desired level of visual acuity desirable for an entertainment system.

In addition to incorporating a graphical display 12, the electronics package suitably incorporates a digital processing unit (DPU) 14 which, as will be described in greater detail below, functions in a manner quite similar to the processing electronics of a convention computer system. Although depicted in the exemplary embodiment of FIG. 1 as being separate from the display unit 12, the DPU 14 might well be integrated with the display in a complete electronic subassembly that, together with a suitable housing, can be inserted into a suitable receptacle provided any convenient location on the rear side of a passenger seat. Each DPU 14 is coupled to a respective display unit 12 and provides all of the control functions necessary to operate the display and to receive and interpret user inputs such that a user or passenger is able to determine what is being shown on the display. In this regard, a passenger interface unit (PIU) 16 is coupled to a corresponding display 12 and is configured to provide a number of systems methods by which a user or passenger is able to access the DPU 14 and command certain functions and operations be performed. For example, a PIU 16 might incorporate volume and tone controls that a passenger might use to configure any received audio signals; a station selector such that a passenger might select between various genres of music, headphones, brightness and color controls and, as will be described in greater detail below, functional select mechanisms such as mouse pens, video game joy-sticks, and the like.

In one particular aspect of the invention, multiple sets of electronic packages, each including a graphics display 12 and DPU 14, along with associated PIU 16, are disposed in multiple locations, i.e., in the backs of multiple passenger seats, in a network configuration. Multiple DPUs are interconnected by a signal bus 18 which functions to allow certain programming content or functionality provided by one particular DPU to be accessible by any of the other electronics packages and thus, any other graphics display 12.

In the particular exemplary embodiment of FIG. 1, the signal bus 18 is depicted as lying between the multiplicity of DPUs and the multiplicity of display units, as well as between the multiplicity of DPUs and a communication management unit (CMU) 20. The particular configuration of the embodiment of FIG. 1 is solely for purposes of illustration and ease of explanation and is not intended to imply that there are two separate signal busses. Indeed, only a single network bus is contemplated by the present invention, with the network bus interconnecting the multiplicity of electronics packages with, for example, an aircraft communication management unit 20.

A communication management unit (CMU) 20 is coupled to the network signal bus 18 and functions to provide certain content signals onto the bus which have been, in turn, derived from various on and off-board signal sources. CMUs are well understood by those having skill in field of aircraft communication reception and distribution systems and function as an interface nexus between various signal sources and aircraft communication and data signal distribution systems. In the exemplary embodiment of FIG. 1, the CMU 20 is configured as an interface nexus between the network system bus 18 and an on-board source of video and audio content, such as a “stack” of digital video disk (DVD) players 22. Further, the CMU 20 provides an interface nexus between the network system bus 18 and a multiplicity of broadband communication devices capable of bi-directional communication with various deployed content providing satellite systems, as well as satellite supported bi-directional voice and data communication systems.

In particular, the CMU 20 is configured to communicate with one or more SATCOM satellite constellations using high-speed, high-frequency communication links utilizing appropriate antennas 26 disposed about the aircraft.

SATCOM communication links have been implemented so as to provide for telephone services, i.e., spoken voice, fax, PC modem data transfer, and the like, as well as computer-to-computer packet data communications utilizing the X.25 protocol. The SATCOM communication network communicates with multiple user receiver stations by means of a Packet Switched Data Network (PSDN) and Packet Switched Telephone Network (PSTN) communication protocols. Thus, communication may be established between any two stations capable of communicating via the COMSAT communication network using, for example, a telephone, a facsimile (FAX) machine, a modem equipped personal computer, and the like. It should be understood that telephone communication may be implemented over any type of voice communication system including cellular phones, PHY phones, analog phones, digital telephones, as well as any other form of voice communication device. It should further be understood that telecommunication networks such as PSDN and PSTN are international ground communication services and are able, therefore, to incorporate any form of ground communication service.

In the exemplary embodiment of FIG. 1, the CMU 20 is coupled to two separate SATCOM interfaces 21 and 23, indicating that it is capable of high-speed, broadband communication with a number of different satellite constellations. For example, the system might be configured to communicate with an Inmarsat SATCOM constellation or a proprietary satellite constellation such as those established by Direct TV, or some other content providing satellite communication network. Thus, SATCOM 1 20 might represent an Inmarsat SATCOM interface, while SATCOM 2, might represent an interface to Direct TV, or the like.

A further interface, a SAT TEL interface 24 might be provide in order that the CMU 20 has access to particular and proprietary satellite telephone communication systems. Although the Inmarsat SATCOM communication network is capable of supporting telephone communication, it is advantageous to have the system according to the invention be able to access a variety of different, proprietary satellite communication network systems such that no one particular satellite system would be burdened with the full bi-directional system communication load of the system according to the invention. Indeed, it would be quite advantageous to have a plurality of satellite communication network choices available to the system's CMU 20 in order to maintain continuity of communications and programming content, in the event that any one of the satellite communication network systems, accessible to the CMU 20 were to experience a significant down-time event or if the aircraft or other vehicle hosting the CMU 20 were to transit between two coverage zones of a particular satellite communication network, thereby experiencing a period of signal nulls.

Having described the components of the exemplary embodiment of a modular in-flight entertainment system in accordance with the present invention, it would be advisable, at this point, to offer some description as to how the components function, in combination, to implement a broadband entertainment content delivery system. Conceptually, the system according to the invention can be characterized as a network, with each of the electronics packages exemplified by a DPU 14 and graphics display 12, and the CMU 20 constituting nodes disposed along the network and interconnected by the network signal bus 18. The CMU 20 functions to provide certain off-board content to the network along with content provided by certain centrally located on-board systems such as a DVD stack. Other content is hosted by, and accessible from, the multiplicity of DPUs comprising the various nodes of the network. In accordance with practice of principles of the invention, each DPU 14 is configured to host a particular application, or application sub-set, on a dynamic basis, so as to constitute in effect a distributed network server system which is able to host multiple applications in the same manner as a single-source, high-capability, broadband network server.

Advantageously, the multiplicity of DPUs are each configured to host individual ones of a number of applications conventionally associated with a central, stand alone server system. A particular DPU 14 might be configured as an e-mail server with appropriate software or firmware e-mail protocol execution routines such that it is able to support e-mail communication between any of a number of users or passengers or their home e-mail server or application. This particular regard, the e-mail application is supported by any particular DPU 14 would allow a user or passenger to send and/or receive e-mail communication by hosting and supporting an e-mail interface over the network 18 which is accessible by a user or passenger through their graphics display 12. Communication between a user or passenger application and the worldwide web is made through the CMU 20 and any one of its interfaces to a satellite voice or data communication system.

Further functionality provided by the multiplicity of DPUs configured as a distributed server system, includes offering a user or passenger access to certain selected cites comprising the World Wide Web. In a manner to be described in greater detail below, a certain one, or certain ones of the DPUs are configured to function as host applications for web sites for a number of entities that have subscribed to the system.

Any DPU so configured would provide the host application for AOL.com, MSNnews.com, CNN.com, and the like. To the extent that entities involved in the World Wide Web subscribe to the system of the invention, a significant portion of the news, entertainment and informational content of the World Wide Web is able to be hosted by a particular one or ones of the DPUs comprising the distributed server and made available to a user or passenger in a relatively transparent fashion.

In a further aspect of the invention, other DPUs are configured to host various other content applications some of which might be associated with particular World Wide Web sites or might represent stand-alone audio/visual applications. In particular, certain ones of the DPUs might be configured to host audio or video media content information in the form of .wav or .vid files that would be accessed by a particular World Wide Web page hosted by a different DPU. Alternatively, the various DPUs comprising the distributed server might host or make accessible any one of a number of different music files, video files, or even certain graphical video game applications that would be accessible not only by that DPUs user, but by all other users or passengers coupled to the network.

Given the ability of the CMU 20 to communicate with proprietary content providing satellite systems, such as Direct TV, the content offered by such proprietary systems is also available over the network. Thus, a passenger is able to avail themselves of almost the complete suite of communication applications available to a person accessing their home or office interface devices. A passenger is now able to listen to music, watch a movie of their choice, access the World Wide Web, send and/or receive e-mail communications, effect cellular telephone communication, read electronically stored books, and have access to broadcast television and/or proprietary broadcast movies, news or other informational content.

In contrast to conventional systems, where a central server controls and coordinates access to each of the various and sundry content sources, the system according to the present invention distributes the various functional application blocks across a multiplicity of host processing systems, so as to create a distributed server architecture. Advantageously, the distributed nature of the processing functions obviates the need for a central server system including its attendant power requirements and the need to allocate precious space to its hardware. It might also be mentioned, at this point, that a distributed server architecture is inherently more capable in terms of processing power than a single, stand alone server architecture. Distributed architectures, wherein each node of the architecture has a particular processing power, are capable of a total processing power equal to the square of the sums of the individual processing powers of each node comprising the architecture. Thus, it should be evident that a distributed server architecture, in accordance with the invention, is more than capable of hosting and supporting the functionality described above. Such a distributed server system is more than capable of providing virtual web access, e-mail, audio and video content to a multiplicity of users in a relatively seamless fashion. In addition, when coupled with the capabilities of the CMU 20, such a system should allow a user or passenger access to virtually every communication media with which they are familiar in their home or office environment.

Thus, the in-flight entertainment and communication system in accordance with the invention is able to provide not only conventionally understood in-flight amusements, such as audio programming, and in-flight movies, but also is able to provide various other forms of content such as access to the World Wide Web, e-mail, broadcast television, cellular telephone communication and other forms of audio/visual entertainment. The system according to the invention is able to thereby provide full and rich entertainment content to passengers in a vehicle that has not heretofore been coupled to the communication and content environment represented by the broadband fabric available in-place and relatively stationery receiving stations.

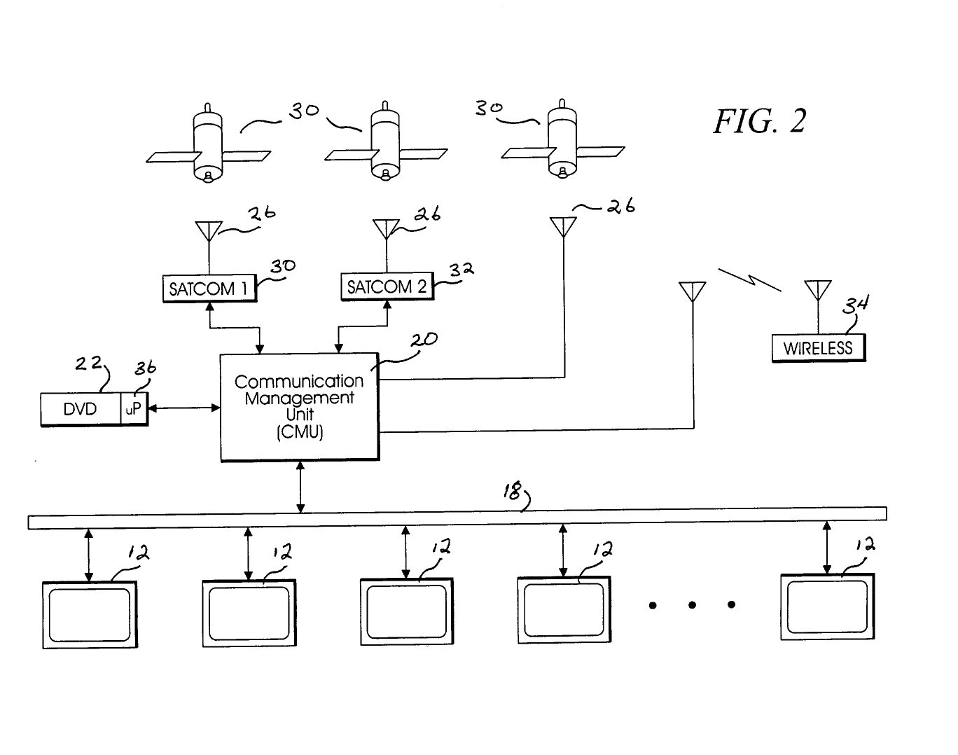

Turning now to FIG. 2, system connectivity is illustrated in a simplified, semi-schematic block diagram form, in which a communication management unit (CMU) 20 forms a communication nexus between a variety of on-board and off-board content sources and provides the content received from such sources to a network system bus 18. In the exemplary embodiment of FIG. 2, content is represented as signals taken from any one of a variety of satellite constellations 30 and received by appropriate antenna systems 26 disposed throughout the vehicle or aircraft. The satellite constellations accessible by the CMU 20 would necessarily include an Inmarsat SATCOM satellite constellation, which is accessible through a, for example, SATCOM 1 interface device 30 coupled to the CMU 20. The SATCOM 1 interface device is an appropriate electronic modulator/demodulator device capable of communicating with Inmarsat SATCOM constellation, in bi-directional fashion, over the appropriate RF frequency assigned to the system.

An additional satellite communication interface, denoted SATCOM 2 32 is also illustrated in the exemplary embodiment of FIG. 2, and represents an interface device capable of communicating with a second satellite constellation, such as Direct TV or some other proprietary, content providing satellite system. SATCOM 2 interface communicates with the appropriate satellite system over an appropriately configured antenna in order to effect bi-directional communication between the satellite constellation and the system's CMU 20. A third satellite communication methodology is incorporated into the system's CMU 20 in a manner that does not require a particular, external satellite-specific interface device such as might be provided for the SATCOM 1 and SATCOM 2 cases described above. Specifically, an aircraft CMU is often configured to communicate with a particular satellite constellation that offers bi-directional communication capabilities between an aircraft and various ground control stations in order to support conventional and well understood flight procedures. As will be described in greater detail below, this particular communication channel is also available to the in-flight entertainment system network as a means of providing not only a communication channel between the aircraft crew and a ground station, but also between airline passengers and a ground receiving station and between the system itself and a connection nexus with the real-time World Wide Web-based information fabric. Accordingly, the system has a great deal of flexibility, not only in the type and degree of content that it is able to extract from various commercial and proprietary satellite systems, but also in the kind and degree of satellite systems it is able to access for bi-directional communication of voice and data. In this wise, the system might be able to not only provide broadcast or proprietary television services to passengers, but also avail itself of any one of a number of communication channels in order to download and/or refresh the content of various web sites contained within memory and hosted by particular ones of the DPUs comprising the distributed information server of the network.

Returning now to FIG. 2, the CMU 20 is also configured to interface with a wireless communication source 34, such as a broadband wireless link provided by an airline ground terminal station, for example at an airline departure gate or a commercial aviation terminal. Ground communication links often terminate at wireless nodes, such that the ground communication channel is able to communicate with particular user devices using a wireless interface link. For example, a local or wide area network might include numerous wireless communication nodes, each adapted to bi-directionally communicate with a user's network node using an RF network interface device. Since the network, according to the invention, is contemplated as forming a vehicle specific local area network, it will be immediately apparent to those having skill in the art that this network can be coupled to a ground based network using conventional wireless interface technology. Indeed, this offers the system an additional approach for connecting to and accessing the World Wide Web, in order to download and/or update the various web pages of the contracting entities, hosted within memory of the particular DPUs identified to perform that function. As will be described in greater detail below, some means of accessing and communicating with the World Wide Web is particularly advantageous in connection with the invention, since much of the interaction between a passenger and the web might involve activities like on-line purchasing or a passenger might wish to contract for a pay-per-view movie offered by Direct TV or some other accessible programming content provider. A passenger is able to access services and pay for those services, by entering a credit card or personal identification number, for example, but the passenger's transaction must necessarily be forwarded to the contracting and providing agency. Therefore, the system needs to be able to register and store such transactions and further be able to communicate those transactions on a relatively frequent and periodic basis to the real-time web or communication environment.

In addition to global connectivity, the CMU 20 is able to interface with a number of on-board audio/video systems, such as a stack of DVD 22 players such as are conventionally provided in modern in-flight movie-on-demand systems. The DVD stack 22 might include its own internal microprocessor control center 36 which functions to queue up individual DVD players within the stack, and also individual video disks accessible by each DVD player. In this fashion, multiple passengers are able to view any particular one of a large variety of movies at any time, without regard to any external timing constraints.

All of the content represented by the various satellite constellations and the DVD stack, is distributed to the network over the network system bus 18 to individual ones of the passenger graphics display units 12. In this manner, a passenger sitting in seat 3B might be watching an in-flight movie, while the passenger sitting immediately adjacent in seat 3C might be communicating via e-mail with their corporate headquarters or some other correspondent. A passenger seated in seat 6A might elect to watch CNN news over a cable channel, while their neighbor is surfing for information in the AOL information database.

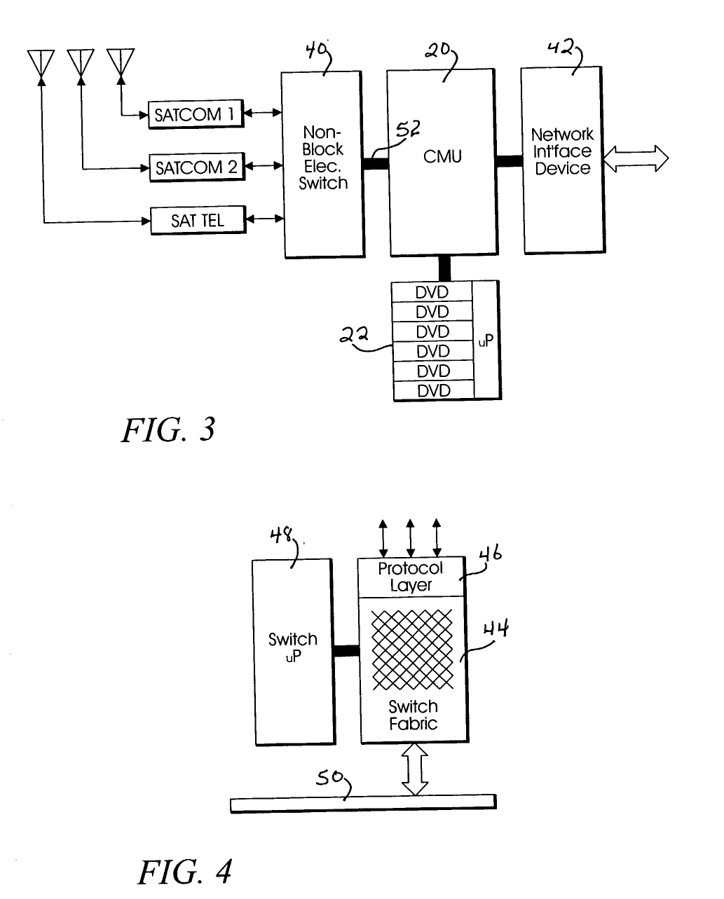

FIG. 3 depicts a common configuration of a communication management unit such as might be incorporated into the in-flight entertainment system of the present invention. The CMU system, generally incorporates a communication management unit (CMU) 20 in combination with a non-blocking electronic switch 40 and a network interface device 42, in turn including electronic circuitry which allows the CMU 20 to communicate over a particular network using that particular network's data and communication protocols. The network interface device 42 is therefore suitably configured to interface between standard CMU outputs and the particular communication protocol desired to be utilized by the aircraft network system. The non-blocking electronic switch 40 is implemented between the main CMU electronics and the satellite or wireless communication interface devices so as to effect bi-directional communication between a particular network node and a particular desired (or selected) communication satellite constellation. Although satellite constellations are normally accessible on an individual basis, it is certainly within the contemplation of the present invention to have multiple satellite constellations accessible by means of multiplexing the various I/O control signals and multiplexing any received audio/video or data signals on to the network bus.

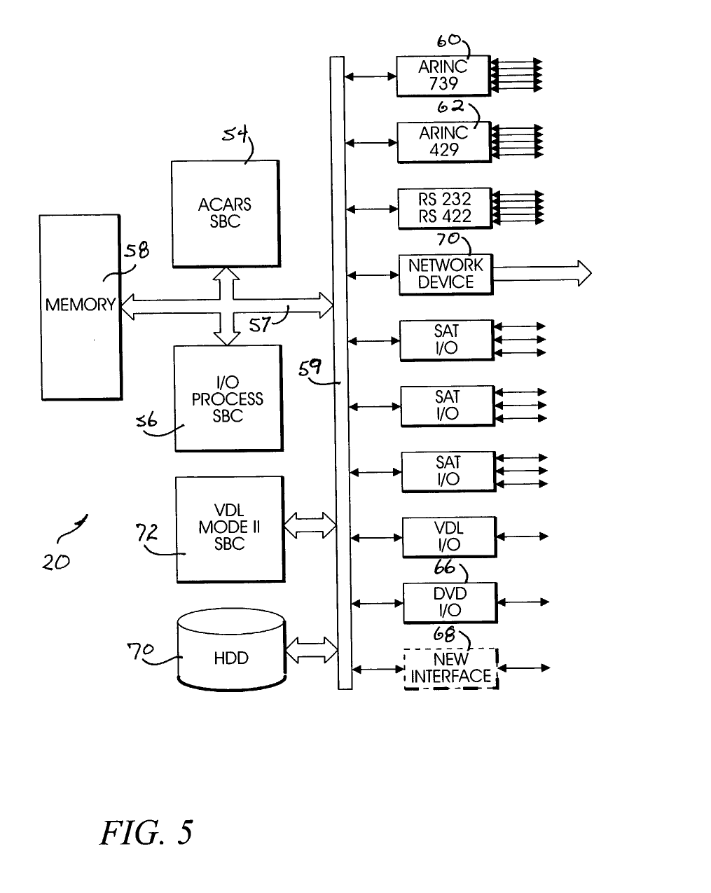

Specifically, and with reference to the exemplary semi-schematic block diagram of FIG. 4, the non-blocking electronic switch is suitably implemented as a conventional switch fabric 44 which is coupled any one of a number of different communication nodes through a protocol layer 46. A microprocessor 48 controls operation of the switch fabric, as well as configuration of the protocol layer 46. The switch microprocessor 48 controls the routing of various signals received from, for example, various satellite constellations to a backplane 50 which in turn, transfers the signals to appropriate circuitry within the CMU 20. Depending on the particular satellite constellation desired, the switch microprocessor 48 controls the switch fabric 44 to adjust the signal path so as to provide for direct connection between the specific satellite I/O interface and the CMU distribution system. The non-blocking electronic switch 40 can therefore be thought of as a routing device or a cross-point connection nexus that ensures appropriate coupling of a signal source to the CMU.

Returning momentarily to FIG. 3, the communication management unit 20 is coupled to the electronic switch by a high-speed broadband signal bus 52. Although not expressly illustrated, it should be understood that the CMU 20 might also be coupled to a control and monitoring display system such as might be accessible to the aircraft's flight crew and/or flight attendants. This particular display system allows flight attendants or crew to receive data from and/or provide data to the system and further allows the flight attendants or crew to monitor various aspects of system usage. For example, any difficulties with or undue loading upon the video-on-demand system, represented by the DVD stack, can be adaptively manipulated by authorized personnel having access to the system through “attendant display system”. Further, a flight attendant or crew member might be able to manually incorporate or defeat various discrete communication interfaces of the sort typically provided within an aircraft CMU in order to tie the system into a conventional passenger information services system (PISS). Such a system is typically implemented in commercial airliners for providing safety audio/visual information to passengers as well as allowing communication between the passenger cabin and aircraft personnel located on the flight deck.

Audio/visual information and data is provided to and extracted from the network system through the CMU 20. The communication management unit also provides an interface to the aircraft's navigational system (NAV) and to an airline communication addressing response system (ACARS), which allows air to ground communication between the aircraft, the airline and other flight associated ground communication nodes. The communication management unit might further provide an interface to a printer, for example, in order to extract hardcopy data reports from the system as well as providing some system of generating paper receipts for various services contracted for by passengers in the course of operating the system.

A conventional system interface unit might also be coupled to the electronic switch (40 of FIG. 3) and functions to drive an aircraft's conventional entertainment system and overhead display devices such as overhead video monitors and an over/seat audio public address system. The conventional system interface unit and its associate overhead video and audio devices, together provide an alternate and backup broadcast system, which allows the airline flexibility in the design of the interior of the aircraft cabin, as well as providing a backup system in the event of a failure of the modular entertainment and communication network in accordance with the invention.

Suitably, the system interface unit might be used to provide conventional audio/visual entertainment sources for a particular group of passengers aggregated in a specific location, such as passengers in coach class, while the modular entertainment and communication system in accordance with the invention might be directed to a particular passenger situated in a second aggregate area, such as business class or first class. In-flight entertainment and communication capabilities can therefore be allocated between and among the various aircraft cabins on the basis of usage, demand and economic ability to pay. Airlines would then have a great deal of flexibility as to how to make content available to various groups of passengers and how to allocate their economic resources in delivering that content to passengers according to passenger fare class.

Audio, video and data communication is passed between the CMU and the various communication nodes of the distributed server system according to the invention, over a network adapted to transmit digital data signal in accordance with a packet transmission protocol, such as TCP-IP, or the like. The actual, physical network coupling is not particularly important to the scope and spirit of the present invention, but it should be noted that the network interconnect is contemplated as being a relatively simple two or three wire communication harness. Category-5 wiring, also known as unshielded twisted pair (UTP) wiring offers a very simple and effective interconnection harness that is quite suitable for use in connection with the network of the present invention. Information can be communicated over UTP wiring systems at relatively high transmission speeds and utilizing bandwidths in the 10 MHz range. CAT-5 wiring schemes have been successfully incorporated in in-home local area network installations, in which existing UTP telephone lines are used to interconnect and effect broadband communication between various home appliances. Broadband communication is implemented in frequency ranges considerably above the frequency ranges reserved for conventional analog telephone voice communication and ISDN data communication over home telephone lines. It has been demonstrated that UTP wiring is capable of supporting very rich multimedia communications. For example, cable television service content can be received and demodulated by a cable modem and then distributed throughout the home environment over conventional UTP telephone lines to various television receivers located throughout the home. Given the broadband communication capability, it would be evident that appropriate broadband content could easily be distributed between and among a multiplicity of passenger viewing stations over simple unshielded twisted pair wiring installations.

This feature is particularly advantageous when it is realized that conventional, prior art systems distribute multimedia content to various individual seat locations using special coaxial cable harnesses or other type-specific communication distribution channels. In order to incorporate these systems into an aircraft, it is necessary to completely rewire the aircraft cabin to accommodate the prior art-type distribution media. This is a very high cost and labor intensive process and involves a significant degree of aircraft downtime for system installation and ongoing system maintenance.

Alternatively, it might be noted that the network signal bus 18 might be implemented as an IEEE 1394 serial bus. The IEEE 1394 Standard For A High Performance Serial Bus, 8.01 v1, issued Jun. 16, 1995, is an international standard for implementing an inexpensive high-speed serial bus architecture which supports both asynchronous and isochronous format data transfers.

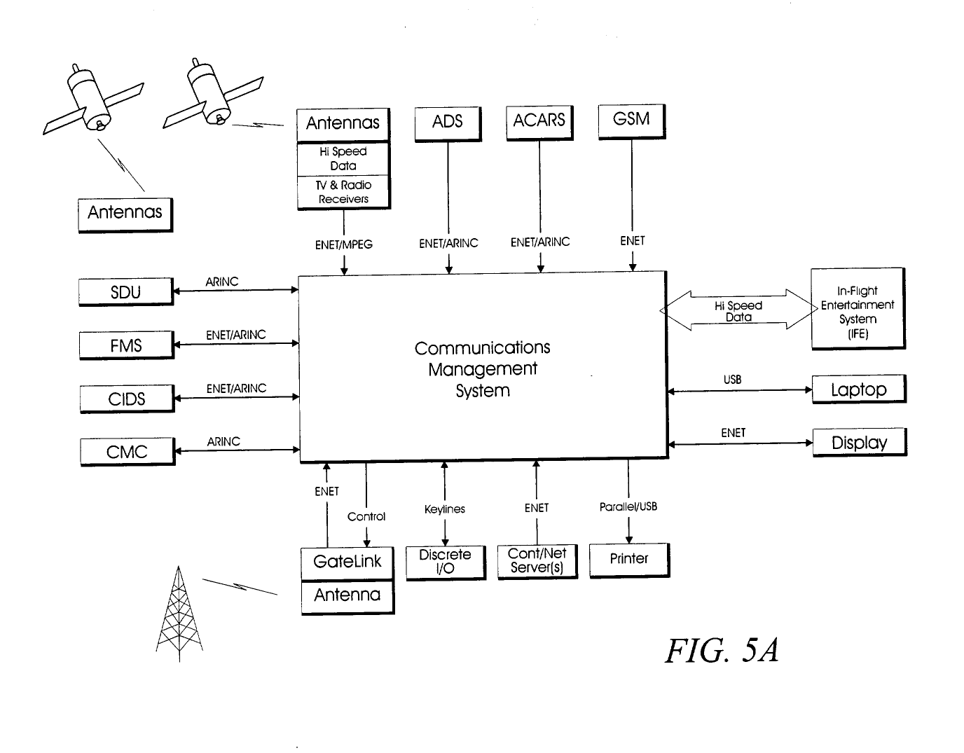

Turning now to FIG. 5, an exemplary embodiment of a communication management unit is depicted in simplified, semi-schematic block diagram form and is illustrated generally at 20. The SMU according to the invention supports numerous bi-directional communication media such as VHF, ACARS, SATCOM, airborne telephone and other modes of modern aircraft and ground communication networks. The CMU is a modular system that includes hardware and software that is versatile, expandable and specific to each individual operator's needs. CMU is designed to interface with an ARINC 739 compliant display, including most modern flight management systems. The CMU further provides extensive digital and analog I/O, an ACARS processor, an internal VDL-mode to VHS transceiver. As such, the CMU supports a choice of bi-directional communication media such as SATCOM, VHF, an airborne telephone and interfaces to peripherals, such as printers and data loaders and thereby provides a complete self-contained, high speed communication unit. Suitable such CMUs are exemplified by the CMU-200 communication management unit manufactured and sold by Pentar Avionics.

A generalized block diagram of the components within the CMU 20 is illustrated in FIG. 5. The CMU is highly modular design with separate high speed single board computers (SBC) dedicated to each of its major functions. An ACARS SBC 54 provides communication protocol and routing functions for the system and is supported by a high speed dedicated I/O process SBC 56 which allows the system to interface with a wide variety of aircraft systems and off-board interface devices. The ACARS SBC 54 and I/O process SBC 56 are coupled by an internal bus 57 to a memory storage unit 58 and an internal system bus 59, such as a PCI bus or one of the various ATA buses. The system bus 59 might be thought of in terms of being a backplane which allows interconnection between and among the various processing modules such as the ACARS and I/O process SBCs and various I/O interface devices through which the CMU 20 communicates with peripheral systems. The system bus 59 is coupled to an ARINC 739 interface 60 which allows external display of various system functions. An ARINC 429 interface 62 provides 12 inputs and 4 outputs to the system for interconnection with ARINC 429 compatible aircraft instrumentation systems. A 4 input, 4 output RS-232 (or RS-422) interface circuit is also coupled to the system bus 59 and might be used for communication with associated portions of a flight attendant or flight crew access device, such as a receipt printer or credit card (Smart Card) access device. It should be noted that the ARINC interfaces 60 and 62 allow for communication with an aircraft cabin passenger management system, and/or a conventional passenger in-flight service system.

The communication management unit 20 further includes multiple input/output devices configured for communication with a variety of satellite constellations, such as Inmarsat SATCOM systems, Direct TV and the like. Magnetic tape readers, floppy disk drives, or an SCSI content loading interface by which content data can be input to the entertainment system are also contemplated for connection to the system bus 59. In this particular regard, an input/output device is represented as a DVD I/O 66 which couples, in turn to a DVD stack for video-on-demand capability.

Content data, such as updated web site information, digital music or video files might be initially loaded into the system through a content loading interface (illustrated as “new interface”) 68 and stored in a high capacity memory buffer 70. The high capacity memory buffer might be implemented in any one of a number of different ways, including implementation as a hard disk drive, a writeable CD-ROM, a dish drive, and the like. This loading of content data into the system is preferably performed while the aircraft is at the terminal being services, but can also be performed by accessing the requisite content sources through any one of the available satellite communication systems. In this manner, the system need not maintain continuous broadband communication with ground content sources. It need only access a ground content source in order to refresh the content hosted by its distributed server system or to add additional web pages, additional web services, or additional music or video files that have become available since the last update or refresh. Necessarily, once the information is acquired by the system, it is directed to the appropriate DPU that has been designated to host that information for long-term storage and for passenger accessibility over the network.

To further this functionality, the CMU 20 of the exemplary embodiment of FIG. 5 suitably includes a network interface device 70 that takes information received through the various other interface devices and transfers their content onto the network in accordance with a suitable packet-based communication protocol.

A further communication mode hosted by the CMU 20 of the present invention is a VDL-mode-to-VHF transceiver, implemented as an additional SBC 72 which is coupled to the internal system bus 59. The VDL mode to VHF transceiver is a numeral 8 PSK broadband transceiver incorporating modern digital signal processing technology, and operating at a frequency of about 118 to about 136 MHz. The VDL mode to VHF transceiver 72 has an associated VDL I/O coupled to the system bus 59 in order to effect off-board broadband communication.

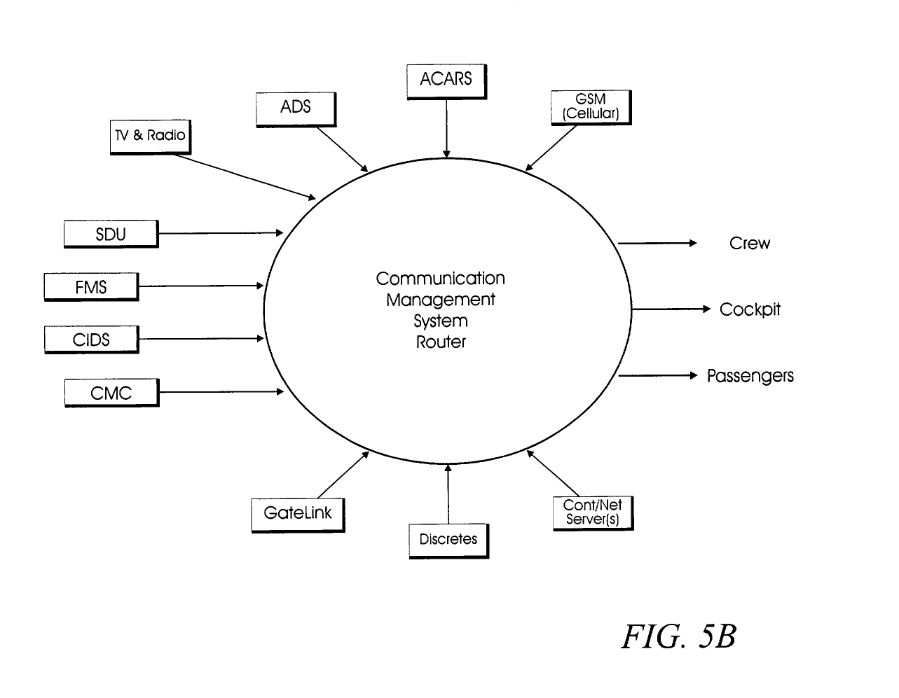

Now that system conductivity has been described in connection with the exemplary embodiment of a CMU as it is shown in FIG. 5, an individual network node will now be described in connection with the simplified semi-schematic partial block diagram of FIG. 6. Conceptually, a network node might be thought of as being a digital signal processor (DSP) or microprocessor controlled computer system, similar to a laptop or palm-type computer. Conventional laptop or palm-type operating system architectures are both eminently suitable to run the various applications that might be hosted by a DPU or network node.

The network node, indicated generally at 14 is controlled by a digital signal processor or alternatively a microprocessor such as an Intel Pentium series microprocessor, a Motorola 68xxx series microprocessor, a Texas Instruments TM320, and the like. The DSP 80 functions to control operation of the entire system and operates in accordance with an executable set of instructions stored in, for example, a memory unit 82. The memory unit 82 might be a single, large scale memory unit but might also be implemented as a number of different memory units, such as a separate read only memory (ROM) and various static or dynamic random access memory circuits (SRAM and DRAM), depending on the type and scale of memory desired in order to support system operation. One having skill in the art of computer architectural design is easily able to determine the types and forms of memory that would be necessary to support a operational computer, knowing only the types and forms of applications that it is desired to have the computer to host.

In this regard, the network node 14 in accordance with the invention might also include an I/O control microprocessor 84 that functions to control the various interface devices that are coupled to the network node to make it accessible to a user or passenger. The various control processors, along with an optional mass storage device, such as a hard disk drive 86 are coupled to various interface devices by system bus 88. The system bus 88 may be configured as a Peripheral Component Interconnect (PCI) bus, an Industry Standard Architecture (ISA) bus or any other appropriate type of data bus. The various control processors may be coupled through the system bus 88 or through an internal data and control bus 89 to the optional system hard drive 86 or the internal large scale memory 82. A series of peripheral interface devices is coupled to the network node through the internal system bus 88 and provide the external functionality of the network node which is accessible by a user or passenger.

For example, a broadcast TV tuner circuit 90 provides the functionality to allow a user or passenger to select among the various broadcast television channels that might be distributed over the entertainment network after having been received from a proprietary satellite constellation. The broadcast TV tuner 90 would be generally conventional in its form and function and connect between the system bus 88 and a graphics display screen 12. Other forms of audio and video content can be directed to the system display screen 12 by means of video and audio interface circuits 92 and 94, respectively. These are provided as separate functions, because although all information is packetized, the information content of a broadcast television signal differs considerably from MPEG or JPEG encoded digital multimedia files. Accordingly, particular interface devices need to be provided to accommodate receipt, modulation or demodulation and/or decoding of various IF or baseband signals.

In the context of a conventional computer system, a different functionality is accommodated by plugging a variety of interface printed circuit boards into a computer system's PCI bus, for example. Thus, audio might be presented to a user by means of a sound card, while a multimedia card offers not only audio but also video content, from multiple sources. Similarly, the broadcast television, video and audio interface devices allow the display screen 12 to show the content derived from a multiplicity of generally incompatible signal sources. A display control interface circuit 96 operates to allow the various display parameters to be accessed and manipulated by a passenger. For example, the display control interface 96 might control screen brightness, screen resolution, and particularly access to user function keys, if the display screen 12 is implemented as a “touch panel”-type display.

Having the screen be a touch panel-type has particular advantages for an in-flight system, since it reduces the number of peripheral devices that have to be coupled to the system and accounted for after the passengers debark. Touch-panel function keys might be disposed about the periphery of the display panel 12 and could be accessed by having a passenger merely depress a certain portion of the display screen or alternatively, have the passenger indicate that a particular function key is being accessed by tapping it with a mouse pen, or some similar device. In this second case, the function keys might be arranged in a manner similar to the location of user accessible “buttons” on a task or tool bar of a WINDOWS® supported application.

A mouse pen 98 or stylus could be connected into an appropriate I/O receptacle provided for such purpose in the display panel 12 if the passenger owns such a device and wishes to use it in connection with the system. Likewise, audio headphones 100 might be coupled into an audio jack on the system's front panel, allowing a user to listen to audio content without disturbing any neighboring passengers.

When the system is being used as a World Wide Web access device, a passenger might often desire to make an on-line purchase of certain merchandise that is made available through certain web pages. A credit card (or Smart Card) reader 102, affixed to the front panel of the system display 12 allows a user to swipe a credit or Smart Card through the reader in order to confirm the purchase of a particular item selected from a web page. Details of the transaction are stored, either temporarily in system memory or are relayed over the network wiring (18 of FIG. 1) to a central mass storage device, such as hard drive coupled into the CMU. Preferably, and in keeping with the distributed nature of the entertainment network in accordance with the invention, transaction details of this sort are maintained in local memory, such that each passenger node maintains all operational records of usages and transactions made by its associated passenger user. This particular configuration minimizes the number of central components necessary to service the system and further reduces administrative overhead demands on the system's available bandwidth.

It bears repeating that each of the network nodes, exemplified by the embodiment of FIG. 6, is a computer architecture having a server-like configuration. Since each of the network nodes is configured as a server as well as a client, it could be evident that the system as a whole incorporates a great deal of processing power. Indeed, the network according to the invention is made up of a plurality of small servers, with its ultimate processing power being equal to the square of the sums of the processing power of each individual server. Configuring the network architecture in this manner completely obviates the need for a large central application server and further obviates the necessary space, weight and power consumption penalties associated with this particular piece of hardware.

A distributed server, in accordance with the invention, can be programmed by one having routine skill in the art, to be not only a broadcast television, audio or video nexus, but also a web server, e-mail server, electronic book server, or a server for any other form of multi-media content delivery contemplated by the fertile minds of broadband information system designers.

Each particular one of the multiple nodes making up this distributed server system is adaptively programmable to support any chosen application or a particular portion of an application as needed. One of the electronics packages might be configured to have its communication node host the e-mail server application for all of the nodes coupled into the network. Even though the corresponding passenger might choose to view broadcast television programming on that node's corresponding display, the broadcast television programming might be provided by an application hosted on a node located two seats back and on the other side of the dividing aisle. All of this functionality is therefore transparent to a user, who need only identify the type of content that they wish to access, or the types of communication that they wish to effect, in order to have it appear on the display or be accessible through their headset or optionally coupled telephone device. Whether or not that functionality is being hosted by the particular node coupled to that display screen is immaterial.

An IEEE 1394 or UTP wiring harness provides a high-speed serial bus for interconnecting the various nodes of the distributed server system, thereby providing a universal I/O connection. Whether IEEE 1394, or VOIP over UTP the network defines a digital interface for the various applications, effectively eliminating the need for any particular application to convert digital data to analog data before it's transmitted across the bus. Correspondingly, a receiving application will receive digital data from the bus and will therefore not be required to do any analog to digital conversions. Devices can be added or removed from the network while the bus is active. Since each network node is considered a separate logical entity, with a unique entity address on the bust structure, as a device is added or removed, the bus will be able to automatically reconfigure itself for transmitting information between the remaining existing nodes.

The in-flight entertainment system of the present invention supports both multicast and broadcast distribution of data to the various network nodes, in addition to the individualized streams of data supporting the video and audio content delivery features. Multicast distribution of data might be used to deliver common data, such as video from an observation camera or data from a passenger flight information system to those passengers who wish to receive it. Such information is made available from various flight systems being coupled to the CMU and thereby to the network bus. In similar fashion broadcast data might be used to delivery public address announcement audio data and video content such as the pre flight safety instruction video in simultaneous fashion to all passengers. If desired, the system can be programmed to place an override priority on such broadcast data, so that it supercedes all other transmissions on the bus.

Although the foregoing discussion has been in terms of providing a wire-base networking infrastructure, such as Ethernet, T1, T3, or the like, it will be evident that the undistributed networking architecture of the present invention is imminently suitable for implementation in a wireless scheme. Wireless local area networks (WLANs) like their wired counterparts, provide high-bandwidth to users in a limited geographical area. WLANs offer a reasonable alternative to the high installation and maintenance costs incurred by traditional additions, deletions and changes experienced in wired LAN infrastructures. Physical and environmental necessities and other driving factor and favor of the use of a WLAN in connection with the distributed architecture of the invention. Typically, aircraft fuselage architectures are planned with network connectivity factored into the cabling plant requirements. Carriers operating existing aircraft (or any other multi-passenger transport device) may find it uneconomic to retrofit existing aircraft for wired network access. Further, the operational environment may not accommodate a wired network or the network may be temporary in operational for a relatively short period of time, making installation of the wired network impractical. This might be true in an “ad hoc” environment, such as a conference, classroom, or any other prompt network environment. Nevertheless, users of wireless networks will require the same services and capabilities they have commonly come to expect with wired networks.

Operation of the wireless network requires that all users operate on a common frequency band. Frequency bands for particular users must typically be approved and licensed in each country, which is a time-consuming process due to the high demand for available radio spectrum. However, any device may transmit in an unlicensed portion of the spectrum, though without a license from the FCC. Unlicensed portions of the frequency band represent what is essentially a free radio spectrum with a very large spectral allocation, available nationwide. The unlicensed frequency band is able to be used for both the fixed wireless and mobile wireless services and allows a very large degree of spectrum sharing, but is nevertheless subject to certain constraints, such as power limitations.

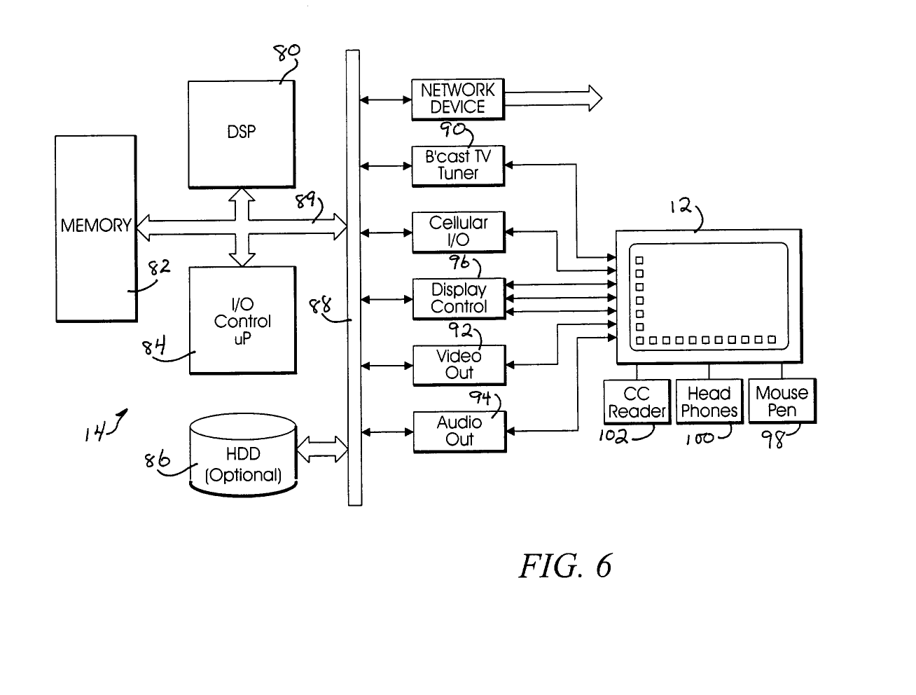

Turning now to FIG. 7, some of the more common unlicensed spectrum allocations are illustrated in terms of their position along a frequency graph in gigahertz (GHz). In particular, the Industry, Science and Medicine (ISM) bands include allocated frequencies at 902-928 MHz and 2.4-2.48 GHz, and are commonly used by existing wireless implementations such as those represented by the IEEE 802.11 standard. An unlicensed PCS band occurs at 1.91-1.93 GHz and is further subdivided into equal asynchronous and isochronous spectra and is contemplated for use with wireless local area networks and wireless PBX installations.

Recently, the U.S. Federal Communications Commission released a 300 MHz spectra, in three 100 MHz subband, in the 5 GHz region, for unlicensed use with highspeed local area network communication services. This spectrum allocation is termed the Unlicensed National Information Infrastructure (UNII) band and resides at 5.15-5.25 GHz, 5.25-5.35 GHz and 5.725-5.825 GHz. Similarly, in Europe, the CEPT has recommended the use of spectrum in the 5.15-5.25 GHz band for so-called HIPERLAN devices in their CEPT recommendation T/R 22-06.

The import of providing for communication bands in the approximately 5 GHz spectral region will become apparent when it is understood that it is now feasible to develop efficient highspeed modulation methods to address communication data rates as high as 54 Mbit/sec. Although utilization of the lower frequency bands, such as the 2.4 GHz band, remains an option as a communication medium for the present invention, but it is less suitable than the higher frequency bands for a number of reasons. In particular, especially in an aircraft environment, other devices either operate on or radiate into the 2.4 GHz band, offering the potential for signal degradation and less than optimal system performance. In particular, microwave devices, cellular telephones, and other personal wireless devices, occupy a portion of the frequency spectrum in the ISM band. Additionally, certain aircraft systems also occupy a portion of the 2.4 GHz band at certain portions of flight operations, and are not very receptive to interference. Additionally, in order to develop a robust methodology for communicating full motion video and the like, the system must be able to resolve the problem of delay spread in the current 2.4 GHz, single-carrier system.

A delay spread is caused by multipath distortion or echoing of transmitted radio frequency signals. As these signals proceed from an origination point to a receiver antennae, they often bounce an echo off objects, walls, etc., and arrive at the antennae at different times due to the different path lengths taken by various components of the signal. Characteristically, of this delay spread must be less than the symbol rate, or the rate at which data is encoded for transmission, or else some of the information is degraded by multipath distortion. This puts a ceiling on the maximum bit rate that is able to be sustained by conventional 802.11 wireless technology. With conventional bit-rate technology, the ceiling tends to be in the neighborhood of about 10-20 Mbit/sec.

Wireless devices based on the IEEE 802.11(a) standard achieve data rates as high as 54 Mbit/sec, and are thereby able to support many broadband applications such as voice over IP, streaming video and video conferencing, making them particularly suitable for implementation in the present invention. In order to achieve these higher bit rates, 802.11(a) devices are utilized in modulation technique termed Coded Orthogonal Frequency Division Multiplexing (COFDM), which has found earlier application in European digital TV and audio transmission. COFDM achieves these higher data bit rates by a transmitting data in a massively parallel fashion and by slowing the symbol rate down, such that each symbol transmission is longer than the typical multipath delay spread in a given installation. COFDM slows the symbol rate while packing an aggressively large number of bits within each symbol transmission, making the symbol rate substantially slower than the data bit rate. Data signals to be transmitted are mapped into several lower-speed signals, or subcarriers, which are then modulated individually and transmitted in parallel. Coding is also used to allow for error recovery and to add additional interference rejection by spreading information across the several subcarriers. If interference occurs on an individual subcarrier, enough data will be still be received in order to permit accurate reconstruction of the symbol. The COFDM physical layer (PHY) thereby allows greater scalability in delivering data over a wireless channel. The larger spectrum allocation in the 5 GHz band can therefore be exploited for greater data rates.

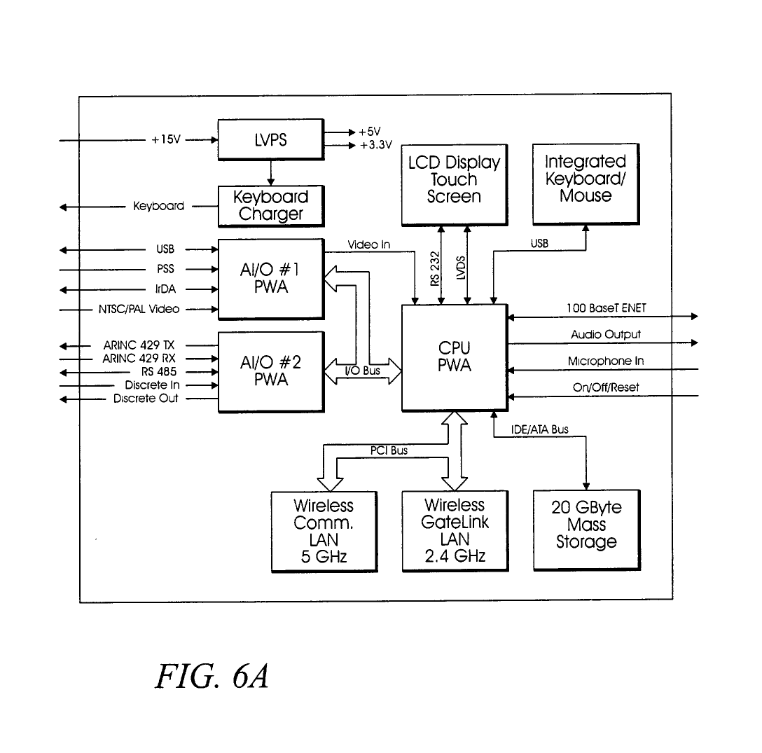

In accordance with the 802.11(a) standard, there are two different ways to configure a local area network; as an ad-hoc network or as an infrastructure network. In the ad hoc network case, and as the depicted in FIG. 8, there is no characteristic structure to the network, in that there are no fixed points and every network node is typically able to communicate with every other network node. An example of ad-hoc network structure is a meeting or a classroom environment, where individuals bring personal, portable computers together in order to communicate and share information. One of the features of an ad-hoc network structure is that there is no one particular network access point which supervises and manages information flow. Although it seems that order would be difficult to maintain in this type of network, algorithms such as the spokesman election algorithm (SEA) may be designated to “elect” one of the network machines as the base station (master) of the network with the other network machines functioning as slaves. Ad-hoc network architectures may also use a “broadcast and flood” methodology by which a transmitting node broadcasts to all other nodes in the network in order to establish who's who.

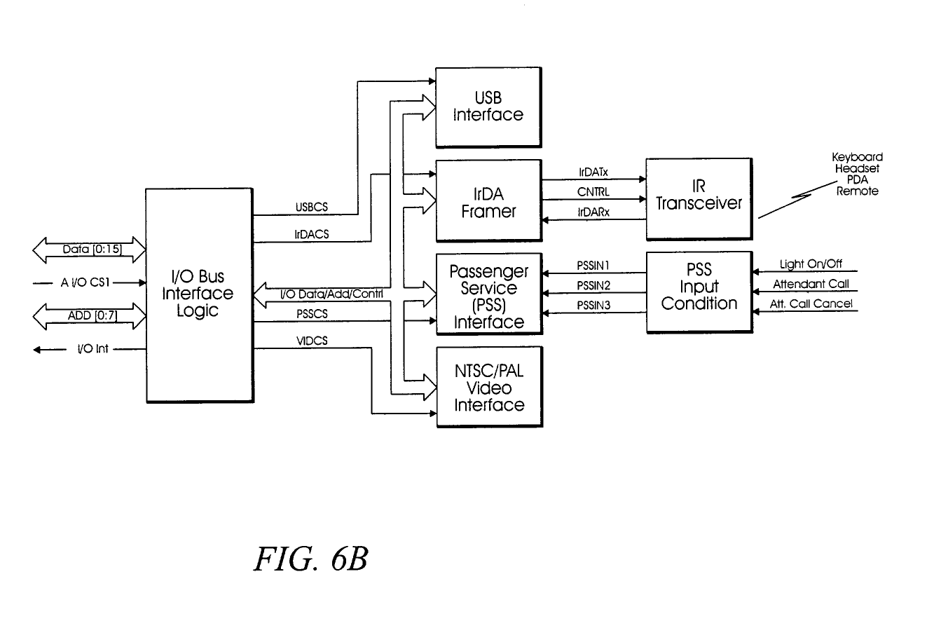

A second type of network structure used in wireless LAN implementations is the infrastructure network, one embodiment of which is depicted in FIG. 9. An infrastructure architecture utilizes fixed network access points with which mobile nodes are able to communicate. These network access points are often connected to wire-based LANs in order to widen a network's capability, by bridging various wireless nodes to a wired node architecture. This structure is very similar to present day cellular networks and is particularly suitable for implementation of the context of the present invention, with the systems' CMU (20 of FIGS. 3 and 5) functioning as a network access point, which coordinates and manages the communication traffic flow for the various mobile nodes comprising the system.

In this regard, the network devices (70 of FIG. 5 and FIG. 6) suitably comprise a broadband wireless network interface device capable of a radio frequency communication within the 5 GHz UNII bands. As depicted in the exemplary embodiment of FIG. 9, the network interface device is comprised of a media access control layer (MAC) and a physical layer (PHY), as is well understood by those having skill in the art. Characteristically, PHY layer details are hidden from the MAC by a PHY specific transmission convergence layer (TC), also termed a MAC interface layer. The MAC layer contemplated for use in connection with the present invention is based on the 802.11 MAC which was designed to support a relatively unreliable RF link operating in an unlicensed band. The MAC protocol is extremely robust and provides a level of reliability which is required by higher level protocols. In particular, the MAC layers instead of protocols which is responsible for maintaining order in the use of the shared network medium. MAC layer protocols involve packetized data transmission and employs a carrier sense multi-access with collision avoidance (CSMA/CA) protocol. In this protocol, when a node receives a packet to transmitted, it first listens to ensure no other node is transmitting. If the channel is cleared, it then transmits the packet. Otherwise, the node chooses a random “backoff” factor which determines the amount of time the node must wait until it is allowed transmit it packet. During periods in which the channel is clear, the transmitting node decrements an internal backoff counter which, when it is decremented to zero, allows the node to transmit the packet. Since the probability that two nodes will choose the same backoff factor is small, collision between packets are minimized.

Whenever an information packet is to be transmitted, the transmitting node first sends out a short ready-to-send (RTS) packet containing information regarding the length of the packet, i.e., its payload length. A receiving node responds with a clear-to-send (CTS) packet and, after this hand shaking procedure is complete, the transmitting node transmit the packet. When the packet is received successfully, the receiving node transmits an acknowledgement (ACK) packet. Successful packet received is determined by a cyclic redundancy check (CRC), as is well understood by those having the skill in the art.

With regard to the PHY layer, the physical layer supports data rates from about 6 to about 54 Mbit/sec, with particular support for 6, 12 and 24 Mbit/sec for downward compatability and for allowing adaptation to various communication link conditions. The PHY operates in the 5 GHz UNII band, with 20 MHz channel spacing, supporting 8 channels in the lower and middle UNII bands and 4 channels in the upper UNII band. In order to ameliorate multi-path distortion, the PHY uses OFDM modulation that splits an information signal across 52 separate subcarriers in order to provide for the transmission of data at a rate of 6, 9, 12, 18, 24, 36, 48 or 54 Mbps. Four of the subcarriers are intended to function as pilot subcarriers that the system uses as a reference to mitigate the effects of frequency or phase shifts during signal transmission. A pseudo binary sequence is provided through the pilot subchannels in order to prevent the generation of spectro lines, with the remaining 48 subcarriers providing separate wireless pathways for transmitting information in massively parallel fashion. Accordingly, the subcarrier frequency spacing, for a 20 MHz band, is about 0.3 MHz utilizing 64 possible subcarrier frequency slots.

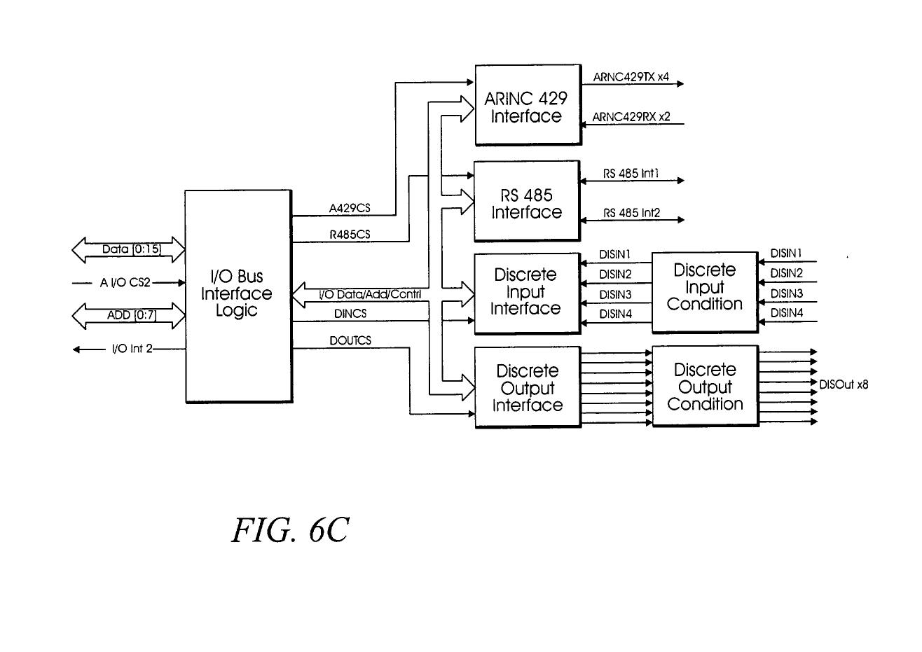

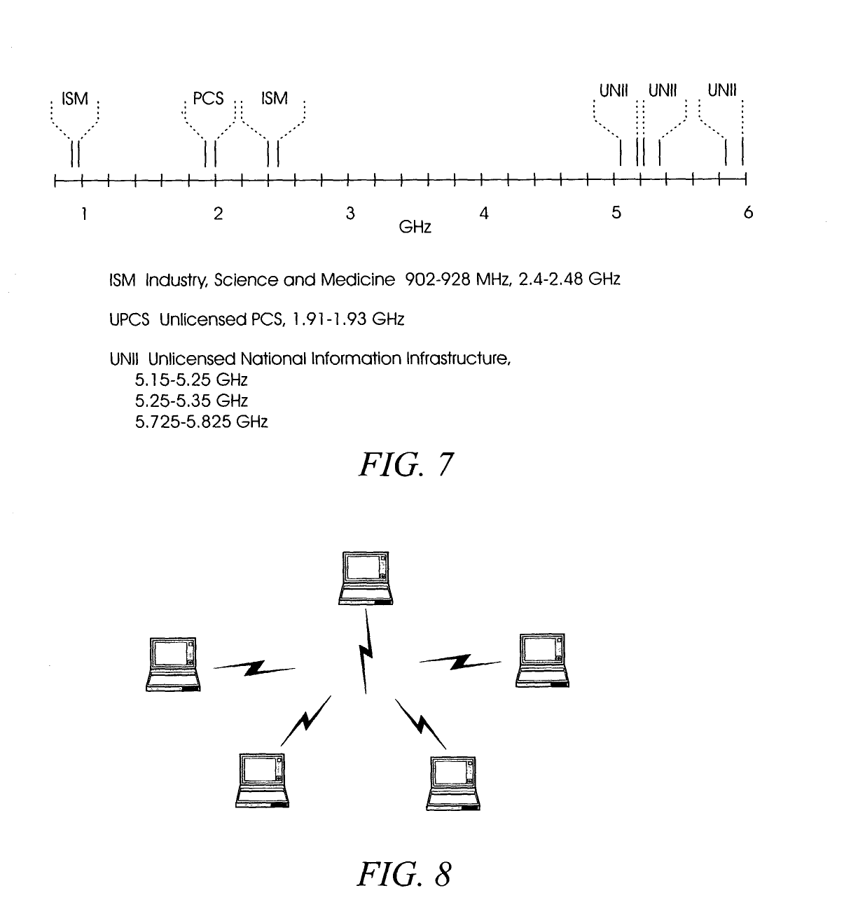

The main function of the physical layer is to transmit MAC protocol data units (MPDUs) as defined and directed by the MAC layer. The PHY provides actual transmission and reception of PHY entities between two stations, through the wireless medium. The PHY interfaces directly with the air medium, by means of an antenna, for example, and provides modulation and demodulation of frame transmissions. The 802.11a version of OFDM utilizes a combination of binary phase shift keying (BPSK), quadrature phase shift keying (QPSK), and various constellation sizes of quadrature amplitude modulation (QAM), depending on the chosen data rate, as indicated in the exemplary OFDM modulation table of FIG. 10. It should be noted that regardless of the frame or packet pay load data rate, the packet preamble and signal field is convolutionally encoded and transmitted at 6 Mbps, using BPSK. The convolutional and coding rate depends on the chosen data rate.

The packet pay load (binary serial data) is formed into symbols of 1, 2, 4 or 6 bits, depending on the chosen data rate, and is modulated into complex representations of applicable constellation points. For example, if a data rate of 24 Mbps is chosen, the PHY maps the data bits into a 16-QAM constellation, as will be understood by those having skill in the art. The resultant constellation is gray coded and each symbol is assigned to a particular subcarrier and subcarriers are combined through an inverse Fast Fourier Transform (FFT) for transmission.

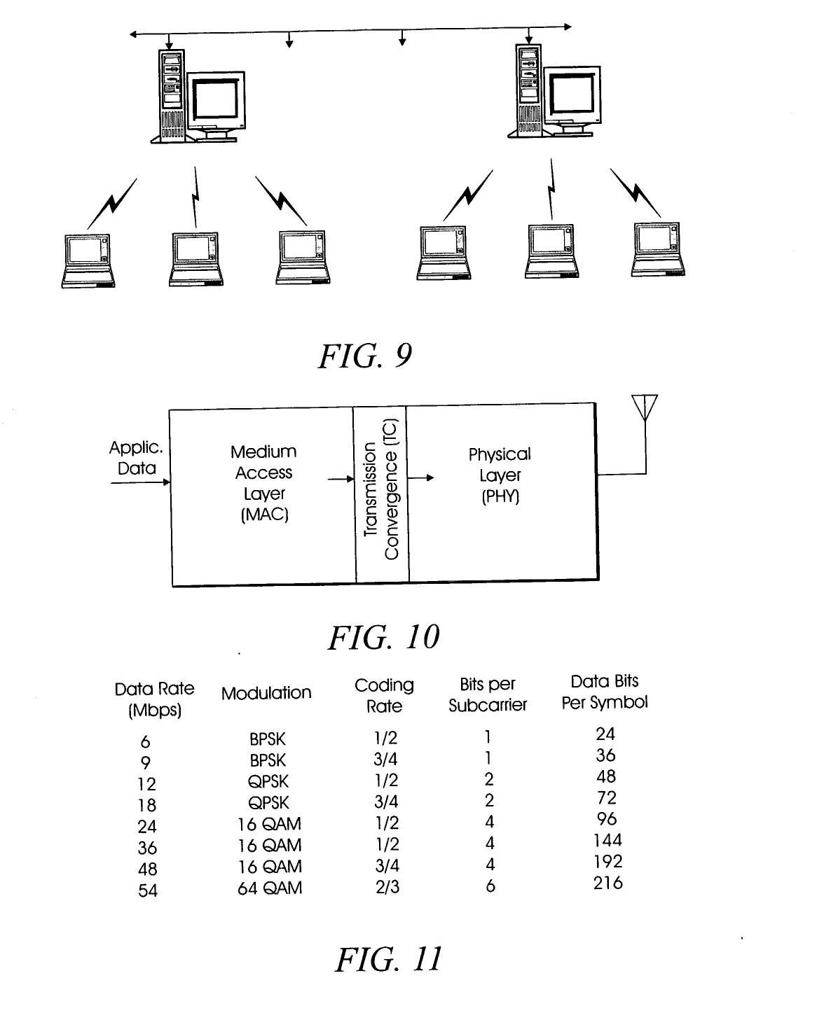

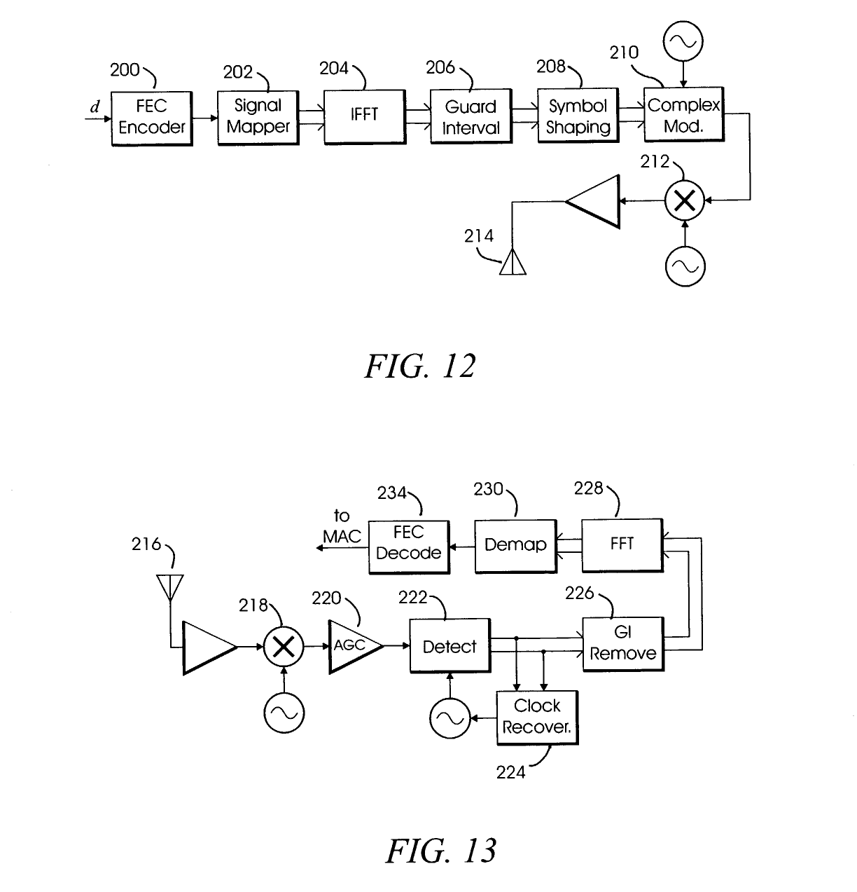

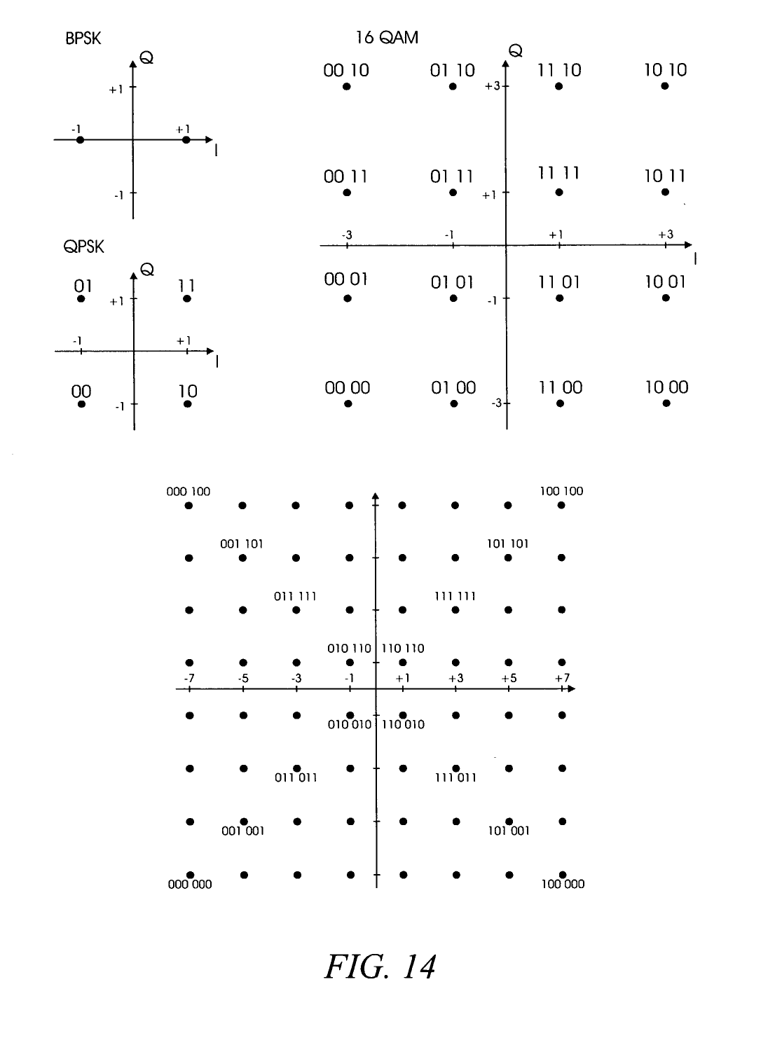

The general block diagram of a transmitter and receiver for the OFDM PHY is illustrated in the exemplary embodiment of FIGS. 12 and 13, respectively. With regard to the transmitter embodiment of FIG. 12, a serial data stream undergoes convolutional encoding in an FEC coder 200 and is mapped to a particular constellation representation in a signal mapper 202. Coded binary signals are mapped to various combinations of BPSK, QPSK, 16-QAM or 64-QAM constellation, depending on the data rate. Examples of BPSK, QPSK, 16-QAM and 64-QAM constellations are illustrated in FIG. 14 and individual constellation mapping values are identified for each point in the signal space. The complex signal, representing each constellation is processed through an Inverse Fast Fourier Transform 204 following which a guard interval is prepended to the signal in block 206. Symbols are wave shaped in wave shaping block 208 following which the signal undergoes IQ modulation in block 210, carrier addition in block 212 and transmission to the media through transmit antenna 214.

The receiver block, exemplified in the illustrated embodiment of FIG. 13 reverses this general process with the signal being received by a receiver antenna 216 and carrier demodulated in carrier recovery section 218. An analog front end 220 provides automatic gain control of the incoming signal prior to timing recovery in an IQ detect section 222. Suitably, time and recovery is performed by a clock recovery circuit 224 that operates, in feedback fashion, to provide a periodic timing signal for the IQ detection circuitry 222. Once the timing section is synchronized, the guard interval is removed from the complex signal in a filter block 226 following which the complex signal is filtered through a Fast Fourier Transform Circuit 228 prior to symbol demapping in an equalizer/symbol slicer 230. Recovered symbols are directed to an FEC decoder 234 whence the recovered digital signal is directed to the receiver's MAC for application processing.

This digression into the structure and operation of a 5 GHz transceiver system will be made clear when it is recognized that wireless transceivers, capable of operating within the UNII bands are implemented as appropriate layers of the network interface device 70 of FIGS. 5 and 6. Appropriate circuitry is commercially available and can be easily implemented in the context of the present invention. This particular wireless transmission methodology is advantageous in the context of the invention since it solves many of the problems observed with conventional wireless and IR systems, particularly in the context of a passenger conveyance such as an aircraft.

Specifically, the system of the invention is contemplated as being hosted in the passenger cabin of commercial or business aircraft with the monitor portion being deployed in the region either immediately above or immediately behind that area of a seat commonly reserved for tray table stowage. Alternatively, the monitor is deployable, on an articulated arm, from the relatively wide armrest structures provided between the seats in the first or business class sections of the cabin. Necessarily, the electronics are disposed elsewhere, either under the seat or within the space defined between the seats. Given the distributed nature of the system, IR transmission is not particularly suitable for the invention since IR is line-of-sight, and the IR transducers for each node of the distributed system, need to have an unobstructed view of its neighbors or of repeaters disposed throughout the passenger cabin. Aside from being a complex installation, repeaters are not foolproof since there is a certain degree of passenger movement throughout the cabin and the opportunity for moving bodies to block a line-of-sight between nodes is rather large.

2.4 GHz wireless transmissions, while more physically robust, do not offer a complete solution, since the problems of multipath distortion and flight system interference remain unsolved. 5 GHz wireless transmission technology, on the other hand, offers the high bandwidth capabilities of IR, while avoiding the signal degradation and interference characteristics of 2.4 GHz systems. It should be understood that in the context of the invention, wireless transmission over the UNII bands offers the most acceptable methodology for effecting full-motion video and information rich multimedia transmissions between and among system nodes and the system CMU.

Therefore, in a mobile environment, such as contemplated by the invention, the electronic packages that comprise the CMU and the individual nodes of the system, may be disposed at any convenient location throughout the passenger cabin, with only a short transmission metric existing between the electronics package and its associated monitor. Since the space associated with a node and its monitor is relatively limited, the monitor might be coupled to the electronics package through an IR interface or a conventional cable. IR transmissions would not be subject to the problems of passenger movement since the IR interface is local to the space occupied by a single passenger. Likewise, conventional cable couplings would be short and would not present the weight and maintenance issues posed by an Ethernet-type network cabling plant disposed throughout the conveyance fuselage.

As was mentioned previously, the particular content which is stored and maintained in the individual network nodes comprising the distributed server of the invention, can be updated or refreshed either while the aircraft or vehicle is being serviced at a terminal, or content might be updated or refreshed in quasi real-time by satellite or VHF access to a ground station. In the event that content is being updated in real-time, only new or previously unloaded content is acquired by the system from the ground station. This allows the system to refresh and update itself with minimal bandwidth use and using a minimal amount of time.

Alternatively, the system can be updated or refreshed when the aircraft or vehicle is connected to a passenger loading gate terminal or by wireless access to a distribution system located at an airlines terminal facilities, for example. During this time, stored passenger transactions such as on-line credit card purchases, are downloaded from the system to a receiving server, by which they are transferred to the net, in conventional fashion. The in-flight network might therefore be thought of as a periodically decoupled network, which mimics certain portions of the World Wide Web at least during the time that the network is effectively decoupled therefrom. As communication links are established with ground stations, the in-flight network is able to refresh and update itself so as to mimic the then, current state of that portion of the web that it is able to host.

It should be mentioned, that web hosting is done by contract, with various content providers making their web site content available to the aircraft operator, and allowing that web content to be uploaded onto the aircraft's distributed network. Thus, the extent of the World Wide Web represented on the in-flight network is limited only by the number of content providers willing to make their content web pages available.

An in-flight entertainment system, in accordance with the present invention, is used to provide a great deal of flexibility of entertainment options to various passengers, by implementing content delivery on the basis of a distributed server system, with each network node implemented in passenger seat. Audio/video-on-demand features of the system are fully interactive, allowing a passenger to stop, pause, fast forward and rewind audio/visual content, as desired. In contrast to prior art-type in-flight entertainment systems, the system of the present invention allows the network to interface with various other aircraft systems, thereby allowing the flight attendants or flight crew to monitor the system's operational parameters, as well as extract inventory management and usage pattern data from the system in order to more efficiently configure for particular passenger loadings and/or routes. Similarly, passengers are able to monitor flight systems, such as cockpit to ground communications, whether radar displays, GPS location information and the like.

The present invention has been described in terms of various exemplary embodiments incorporating particular details which facilitate the understanding of principles of construction and operation of the present invention. Reference to such specific exemplary embodiments is not intended to limit the scope of the invention but rather intended to illuminate the various features and aspects of the invention through a contextual description. It will be immediately apparent to one having skill in the art, that the specific configuration and operational details of the various component parts of the distributed network can be implemented in numerous different ways while accomplishing substantially the same object. Thus, many modifications may be made in the various embodiments chosen for illustration, without departing from the spirit and scope of the present invention. Rather, the invention is intended to be defined solely by the scope of the appended claims.

What is claimed is:

1. A multi media communication network for a passenger vehicle, comprising:
a plurality of display devices, each device including at least a control processor, a local memory storage area and a display;
a local area network including a serial wiring harness, the harness interconnecting each of the plurality of display devices; and
wherein each of the plurality of display devices is configured to include a server device portion and a client device portion, each of the plurality of display devices cooperating over the local area network so as to define a distributed server local area network architecture.

2. The multi media communication network according to claim 1, wherein each of the plurality of display devices defines a network node of the distributed server local area network architecture.

3. The multi media communication network according to claim 2, further comprising:
a plurality of content providing application software routines; and
wherein particular ones of the plurality of content providing application software routines are stored on corresponding particular ones of the plurality of network nodes, such that each network node hosts only a specific sub-set of the plurality of content providing applications.

4. The multi media communication network according to claim 3, wherein the content providing application software routines are selected from the group consisting of internet web site pages, audio-on-demand, video-on-demand, cellular telephony, e-mail, and broadcast television.

5. A modular multi media communication network for a passenger vehicle, comprising:
a plurality of display devices, each display device disposed in a location separate from other ones of the plurality of display devices, each display device including at least a control processor, a local memory storage area and a graphical display screen;
a local area network signal bus interconnecting each of the plurality of display devices; and
a communication management unit, coupled to the network signal bus, the communication management unit further coupled to multiple bidirectional communication interface devices, each communication interface device effecting real-time communication with a different one of a multiplicity of substantially incompatible signal sources.

6. The modular multi media communication network according to claim 5, wherein the multiplicity of substantially incompatible signal source comprises:
a first satellite constellation, providing a first type of content;
a second satellite constellation providing a second type of content; and
a broadband bidirectional VHF communication medium.

7. A modular multi media communication network for a passenger vehicle, comprising:
a plurality of display devices, each display device disposed in a location separate from other ones of the plurality of display devices, each display device including at least a control processor, a local memory storage area and a graphical display screen;
a local area network signal bus interconnecting each of the plurality of display devices;
a communication management unit, coupled to the network signal bus, the communication management unit further coupled to multiple bidirectional communication interface devices, each communication interface device effecting real-time communication with a different one of a multiplicity of substantially incompatible signal sources; and
wherein each of the plurality of display devices is configured to function as a network server, each of the plurality of display devices cooperating over the local area network signal bus so as to define a distributed server local area network architecture.

8. The modular multi media communication network according to claim 7, wherein each of the plurality of display devices defines a network node of the distributed server local area network architecture.

9. The modular multi media communication network according to claim 8, further comprising:
a plurality of content providing application software routines; and
wherein particular ones of the plurality of content providing application software routines are stored on corresponding particular ones of the plurality of network nodes, such that each network node hosts only a specific sub-set of the plurality of content providing applications.
